(19) United States
(12) Patent Application Publication
(10) Pub. No.: US 2017/0371184 A1
(43) Pub. Date: Dec. 28, 2017

(54) Smart Contact Lens With Orientation Sensor

(71) Applicant: RaayonNova LLC, Fair Lawn, NJ (US)

(72) Inventor: Aleksandr Shtukater, Fair Lawn, NJ (US)

(73) Assignee: RaayonNova LLC, Fair Lawn, NJ (US)

(21) Appl. No.: 15/330,969

(22) Filed: Jul. 17, 2015

(51) Int. Cl. G02C 11/00; G02B 27/00; G02C 7/04; G02B 27/01; H04W 88/02; H04W 4/02

(52) U.S. Cl. CPC G02C 11/10; G02C 7/04; G02B 27/0172; G02B 27/0176; G02B 27/0093; G02C 2202/20; H04W 4/02; H04W 88/02

(57) ABSTRACT

Current invention propounds a novel active contact lens device, system, as well as, a corresponding method of operation of such contact lens with an embedded orientation determination mechanism. The system, furthermore, utilizes an onboard, integrated orientation and gaze sensing component to determine eye orientation, in 3D (x,y,z) dimension corresponding to the direction of eye gaze, or in 2D (x,y) dimension, denoting orientation relative to the horizontal or vertical line of the eye, also known as, the horizontal or vertical meridian of the eye. Such a system may be used to provide rich augmented reality (AR) or virtual reality (VR) experience to its user/wearer. Hereby, we propose to incorporate several electronic, electro-optical, optical or other types of components into the contact lens substrate and interconnect them to form such an innovative AR/VR enabled active contact lens system. The system proffered herein, may incorporate and integrate a number of the following components: an integrated orientation sensing module, a positioning module (a location determination module—for example GPS sensor), an integrated substantially transparent, or semi-transparent, or non-transparent display device, a source of electric power, a communication component, a processing component, and an audio output device. Some constituent modules may be integrated into the lens substrate and some may be located remotely and accessible via wireless communication channel. The smart contact lens with an embedded orientation module may be used to implement a variety of reactive, adaptive, predictive, behavior monitoring and analyzing systems.

### SUMMARY

Currently, all of the available systems and applications that depend on and require knowledge of the eye direction/gaze (3D orientation), determine eye gaze by tracking eye movements from external, relative to the eye, platforms. For example, Microsoft HoloLens device for AR applications, Oculus for VR applications, and a variety of medical systems all have built in, eye facing cameras to track eye position. In military applications, helicopter or fighter plane helmet will track pilot's direction of gaze by tracking eye movements.

A variety of medical, military and industrial applications exist where external device tracks eye position at any given time. However, relying on external eye position tracking systems, which are usually bulky, sets limits on usability and introduces inconveniences for use of such systems. Hence, it is deemed highly beneficial and meaningful to enable eye position and orientation determination/gaze tracking in the way independent from external eye observer and tracker. We propose a system and a corresponding method where contact lens will be integrated with an onboard orientation determination module and will be fully independent from any external tracking system. This solution enables smart contact lens with eye direction/gaze awareness.

A miniaturized sensor component embedded into the contact lens would fundamentally change the landscape of applications possible; it should augment the use of eye direction knowledge and enable many AR, VR and other applications.

In one non-limiting exemplary embodiment, the contact lens system, hereby proposed, inter alia, may be arranged to be configurable and reconfigurable with a particular AR context for processing. For example, the system may be configured to provide the user with information about current whereabouts of the user and based on the user's gaze, the system may provide relevant information about buildings being looked at by the user.

In one non-limiting exemplary embodiment, the system may be configured, for example, in urban setting, with a context of history, to provide historical information of buildings, parks, museums, opera houses being looked at by the user. Corresponding audio information may be fed to headphones/speakerphones. Corresponding images and video information would be fed to the embedded transparent or non-transparent display device. In this embodiment, the system may serve as an educational tool for students or tourists.

In one non-limiting exemplary embodiment, the system may be configured, for example, with a context of navigation to provide navigational instructions. With every eye movement, navigation instructions may be adjusted to reflect field of view change relative to proposed navigation instructions. Navigation instructions may be fed onto an integrated contact lens-based transparent or non-transparent display. Corresponding audio instructions may be fed to headphones. In this embodiment, the system may serve as a navigation system.

In one non-limiting exemplary embodiment, the system may be used to track and classify user's behavior and interests.

Furthermore, the system may be configured, for example, to collect statistics on user gazing patterns for future use. For example, for the purposes of customizing advertisements delivered to the user, either in the form of video presented on the transparent or non-transparent display embedded into the lens substrate, or alternatively the advertisement may be delivered in the form of audio form to the user's headphones/speakerphones. Alternatively, the advertisement may consist of both visual and audio messages.

In one non-limiting exemplary embodiment, the system may be used to determine orientation in 2 dimensions (x,y) relative to the horizontal and vertical meridians of the eye.

Such orientation capability, relative to the horizontal and vertical line of the eye, has a number of important uses. One critically important application is the capability to orient an embedded display system in such a way so that the display data is viewed in proper vertical and horizontal alignment relative to both eyes.

### DESCRIPTION OF DRAWINGS

The features which are believed to be characteristic of the present disclosure, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this disclosure will now be described by way of example in association with the accompanying drawings in which:

FIG. 1 illustrates a contact lens system with an embedded orientation sensor, in accordance with an embodiment of the present disclosure;

FIG. 2A illustrates a contact lens system with variety of embedded electronic components, in accordance with an embodiment of the present disclosure;

FIG. 2B illustrates a contact lens system with variety of embedded electronic components, in accordance with an embodiment of the present disclosure;

FIG. 3 illustrates a contact lens system with variety of embedded electronic components and embedded energy harvesting component, in accordance with an embodiment of the present disclosure;

FIG. 4A illustrates a contact lens system with variety of embedded electronic components, in accordance with an embodiment of the present disclosure;

FIG. 4B illustrates a contact lens system with variety of embedded electronic component and its insertion angle, in accordance with an embodiment of the present disclosure;

FIG. 4C illustrates a contact lens system with variety of embedded electronic component and its insertion angle, in accordance with an embodiment of the present disclosure;

FIG. 5 illustrates a contact lens system with variety of embedded electronic components, in accordance with an embodiment of the present disclosure;

FIG. 6 depicts a contact lenses system with variety of embedded electronic components, in accordance with an embodiment of the present disclosure;

FIG. 7 depicts a flow diagram, in accordance with an embodiment of the present disclosure;

### DETAILED EMBODIMENTS

The foregoing summary, as well as the following detailed description of certain embodiments of the subject matter set forth herein, will be better understood when read in conjunction with the appended drawings. As used herein, an element or step recited in the singular and preceded with the word “a” or “an” should be understood as not excluding the plural form of said elements or steps, unless such exclusion is explicitly stated. In this document, the term “or” is used to refer to a non-exclusive or, unless otherwise indicated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

The object of the present invention is to provide a bionic AR-enabled or VR-enabled contact lens system. To this end, such a system may be equipped with a directional orientation sensing component to determine the direction of the user's gaze; an integrated location determination module to determine user's location; a transparent or semi-transparent or non-transparent display device built into the contact lens substrate; a processing/controller component, as well as, a communication device. The system may also utilize locally or remotely available source of data, some of which may be GEO-enhanced information that, after being processed, may be output to the display or audio devices.

The system generates augmented reality experience for points of interest. A point of interest is defined as a location of an object or a group of objects, either absolute or relative, for which the system needs to generate the germane information. A point of interest may be expressed in terms of location coordinates of the user, as determined by positioning module (such as GPS), or a directional orientation of the user's gaze, as determined by the orientation module. A point of interest may also be expressed in terms of both location coordinates and orientation of gaze.

As used herein, the terms “software”, “firmware” and “algorithm” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

The various embodiments and/or components, for example, the modules, elements, or components and controllers therein, also may be implemented as part of one or more computers or processors. The computer or processor may include a computing device, an input device, a display unit and an interface, for example, for accessing the Internet or Intranet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

Electronic components, memory, processors, controllers and variety of sensors may be implemented as Micro Electro Mechanical System (MEMS). Electronics may be implemented as Nano electronics.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical processing units (GPUs), logic circuits, and any other circuit or processor capable of executing the functions described herein. The above examples are exemplary only, and are thus not intended to limit in any way the definition and/or meaning of the term “computer”. In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense, and the scope of the subject matter disclosed herein is defined by the appended claims and their equivalents.

An active contact lens transparent substrate may be formed based on conventional PMMA or RGP materials that are shaped to be worn over the user's eye. PMMA (Polymethyl Methacrylate) or RGP (Rigid Gas Permeable) are the most likely candidates to be used for contact lens substrate. Other gas permeable or non-gas permeable materials may be used or combination thereof.

There are several cornea specific health considerations that may affect the choice of underlying substrate material:
a) Oxygen permeability. It is well known that cornea is an avascular biological tissue that derives its sustenance (oxygen & nutrients) from its environment. PMMA has low oxygen permeability, and there is evidence that suggests that PMMA may lead to a reduction in mitotic rate of epithelial cells. This may lead to a partial disabling of cornea's repairing capabilities and may cause damage to the eye. Hence, PMMA is not recommended for use for periods longer than eight hours per day. RGP, on the other hand, has much higher oxygen permeability and allows for the delivery of sufficient amounts of oxygen to the cornea; therefore RGP-based substrate may be used for longer periods of time.
b) Another important consideration is that the temperature of the active contact lens may affect the temperature of the eye. The temperature of the cornea is usually around 34 degrees Celsius and it is slightly higher (by about 0.50 degree Celsius) at the cornea's border with the sclera at the corneal limbus. Increased temperature can lead to corneal cell damage due to increased epithelial metabolic rate and increased oxygen consumption. There are studies that found that corneal temperature increases, caused by ultraviolet or radio frequency radiation, damage corneal cells at the temperatures ranging above 41 degrees Celsius. Given that we are considering an active contact lens with a number of integrated Nano or microelectronic components, heat dissipation and heat conductivity of underlying substrate materials is a big concern. Both PMMA and RGP have acceptable levels of heat dissipation and conductivity for use with Nano and microelectronic components. There are several stratagems available to alleviate heat dissipation and conductivity concerns. First, for electrical circuitry and wiring of electronic and electro-optical components, the system may utilize materials with good conductivity and hence, low resistance, such as: 1) traditional semi-conductors, such as high purity cooper, silver, gold; 2) materials with superconductivity or near superconductivity—a variety of alloys: niobium-titanium, germanium-niobium, niobium nitride; 3) a variety of ceramic materials, for example, magnesium diboride, as well as, carbon nanotubes and fullerene materials. Newer materials, like graphene or graphyne, may also be used. Transparent materials may be used to implement onboard wiring or electronic components, such as Indium tin oxide (ITO). At the moment of this writing, there are several experimental implementations of transparent electrodes made with a combination of graphene and silver Nano wires. The benefit of this combination is great mechanical flexibility and stretch ability, as well as, very low sheet resistance providing good conductivity and low heat generation.
Second, wiring may be isolated in a specialized channel made of materials that both have low heat conductivity and can serve as electric insulators: polyethylene, ceramic and many other materials may be a good fit.

The present invention incorporates an orientation sensing module (OSM) integrated into the contact lens substrate. Orientation sensors may comprise a variety of compass, magnetometer, gyroscope, tilt sensor, rotation vector sensors/orientation vector sensor, accelerator and other orientation sensors. Orientation module may comprise Inertial Measurement Unit (IMU). Sensors may be implemented with Micro-Electro-Mechanical Systems (MEMS) technology. Sensors may be implemented as Nano or micro sensors. OSM may also include a variety of depth sensors that can orient relative to the outward geometry and determine current orientation of the contact lens; thereby, determine the direction of the wearer's gaze.

A variety of configurations of the orientation module is possible, such as, Inertial Navigation System (INS) aka Inertial Measurement unit, which generally combines multi-axis accelerators and gyros, as well as, magnetometer (sub-type of compass). INS may optionally combine other types of sensors that determine and yield spatial directional, rotational, spin or tilt measurements.

In one non-limiting, exemplary embodiment, an integrated orientation module may comprise an accelerator unit. The accelerator may be multi-axial. The accelerator may be a tri-axial unit, consisting of three linear or angular accelerometer sensors that are aligned in (x,y,z) axes respectively, where each accelerator sensor measures acceleration in its dedicated, specific dimension (axis) Accelerators are arranged orthogonally relative to each other. Output of the accelerometer unit may be measuring force (including gravity) applied onto the sensor in m/s² units in all three physical axes (x,y,z). The output indicates motion (tilt/position shift).

In one non-limiting, exemplary embodiment, an integrated orientation module may comprise a gyroscope sensor. A gyroscope sensor may be multi-axial. A gyroscope unit may measure angular velocity relative to any specific dimension. Output of the gyroscope sensor may be in rad/s units around each of the three physical axes (x,y,z) indicating rotational spin/turn.

In one non-limiting, exemplary embodiment, an integrated orientation module may comprise a magnetometer/electric compass sensor. The magnetometer may be multi-axial. The magnetometer determines the direction of the magnetic field at any point in space by measuring the strength of ambient geomagnetic field for each of the three physical axes (x,y,z). Output of the magnetometer sensor may be measured in μT units. The magnetometer serves as a compass, to indicate direction with respect to the Earth's magnetic fields: North and South poles. The magnetometer may be implemented as a vector magnetometer measuring magnetic fields as vector quantities, characterized by both strength and direction. Magnetometer measurements may be either absolute or relative. The magnetometer may be implemented as a multi-axial magnetometer, for example, as a tri-axial magnetometer.

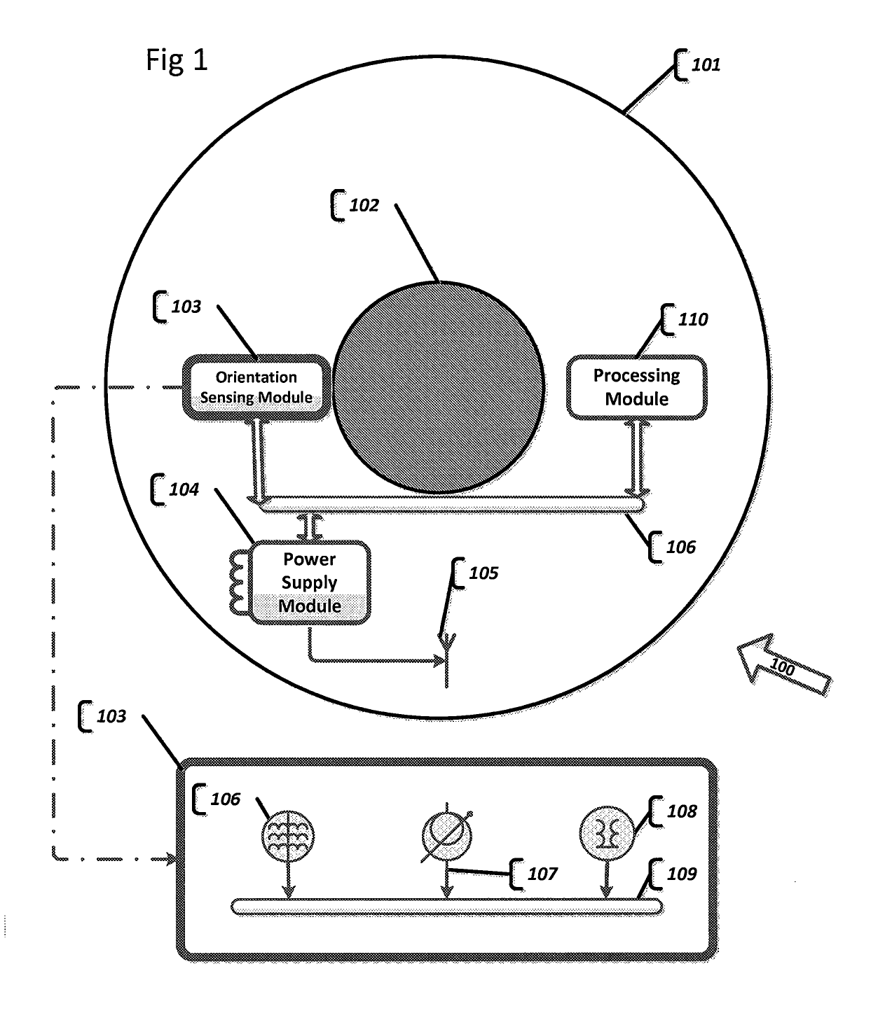

In one non-limiting, exemplary embodiment, as per FIG. 1, an active contact lens device 100 is depicted. An active contact lens substrate 101 may be composed of transparent, semi-transparent or non-transparent composite material, or a combination of materials for different layers of substrate, for example, a combination of RGP and graphene, with embedded silver nanowires serving as conducting materials to transmit electronic signals.

In one non-limiting, exemplary embodiment, an active contact lens substrate may be composed of transparent PMMA or RGP or other material with acceptable degree of oxygen permeability and heat dissipation. In one non-limiting, exemplary embodiment, an active contact lens substrate may be composed of various transparent polymer materials or any other material that can yield transparent substrate.

In one non-limiting, exemplary embodiment, the smart contact lens may be arranged with directional orientation sensing module (OSM) 103. Orientation sensors may comprise a variety of compass, magnetometer, gyroscope, tilt sensor, rotation vector sensors/orientation vector sensor, accelerator and other orientation sensors.

In one non-limiting, exemplary embodiment, as per detailed view of OSM component 103, OSM may comprise: a magnetometer (electronic compass) 106, an electronic gyroscope 107, and an electronic accelerator 108. Orientation sensors may be multi-axial. The orientation sensors, for example, may be tri-axial, measuring orientation relative to three axes (x, y, z).

In one non-limiting, exemplary embodiment, an OSM component 103 may be embedded into the contact lens parallel to the eye, on the z-axis, as measured by OSM, and aligned with a central axis of an outward looking eye gaze and orthogonal to the view seen by the eye.

In one non-limiting, exemplary embodiment, an OSM component 103 may be embedded into the contact lens under a specific angle offset relative to the centerline of an eye. Stated differently, the z-axis as measured by OSM, is not parallel to the eye gaze. Expressed differently, the z-axis, as measured by OSM, is orthogonal to the tangent line of the exact location on the substrate where OSM is embedded.

In one non-limiting, exemplary embodiment, all of orientation determination sensors are connected to a Controller and Communication bus 109. The OSM Controller and Communication bus 109 coordinates operation of OSM integrated sensors and serves as a communication channel to further output OSM measurements to a Processor module 110.

In one non-limiting, exemplary embodiment, Processor module 110 may function as a controller of the contact lens system, thereby coordinating proper operations of all components of the system. Processor module 110 may comprise a) a processor, which may be a general purpose processor (CPU), b) operating RAM memory, ROM memory, EPROM memory, EEPROM memory, and non-volatile RAM (NVRAM) memory, and c) permanent memory. Electronic components, memory, processors, controllers and a variety of sensors may be implemented as Micro Electro Mechanical System (MEMS). Electronics may be implemented as Nano electronics.

In one non-limiting, exemplary embodiment, an OSM component 103 may comprise an integrated processing module, arranged to determine an orientation of the eye gaze based on OSM sensors' measurements.

In one non-limiting, exemplary embodiment, component 102 depicts a transparent area of the contact lens that may be a see-through substrate or may integrate a transparent, semi-transparent or non-transparent display device.

In one non-limiting, exemplary embodiment, an active contact lens may be equipped with a Power supply module 104. Power supply module 104 provides electric power to the entire active contact lens. Power supply module may derive electric power from energy transfer antenna 105. Antenna 105 may receive its power from an RF power source. Power supply may comprise a capacitor unit, a battery or an accumulator unit to continue to supply electricity from the local storage when the external power delivery is not available. Power supply module may derive low powered voltage from an embedded solar panel.

In one non-limiting, exemplary embodiment, electric or electro optical components of an active contact lens are connected by an electric circuitry 106. Electric circuitry serves several purposes: it supplies electric power to all components of the system and serves as a communication channel between different components of the system. For example, it may channel OSM measurements to processor module 100.

In one non-limiting, exemplary embodiment, a software API or hardware solution may be implemented to track orientation of the user by providing access/interface to rotation matrix. The rotation matrix may be implemented to confirm to the OpenGL standard. Namely, OpenGL matrices are column-major matrices and as such, must be transposed before being used. Since the matrix is a rotation matrix, its' transpose is, in fact, also, its' inverse and since the inverse of a ration matrix is normally required for rendering, it can be directly used with OpenGL ES.

In one non-limiting, exemplary embodiment, a software API or hardware solution may be implemented to track orientation of the user by providing inclination based on the rotation matrix (for example, measured as angle in radians).

In one non-limiting, exemplary embodiment, a software API or hardware solution may be implemented to track orientation of the user by providing orientation based on rotation matrix (for example, measured as combination of three parameters: azimuth—Z axis, pitch—X axis, roll—Y axis). Axis may vary in what it measures, at the moment of the writing there is a variety of known orientation sensors capable of measuring orientation in multidimensional—multi-axial systems, there might be 1 or 2 or 3 or 6 or 9 axial measurements. Different number of axes is possible. The reference coordinate system used may be world coordinate system or any other alternative coordinate system defined for the rotation matrix.

In one non-limiting, exemplary embodiment, a software API or hardware solution may be implemented to track orientation of the user by providing tilt.

Other orientation related parameters may be exposed by the software API or hardware solution.

In one non-limiting, exemplary embodiment, output of the variety of orientation sensors is correlated and collated to yield high resolution directional orientation parameter.

It should be understood that other variations of the sensor implementations are also possible. A variety of combinations of orientation specific sensors is possible to form an orientation module. Provided description of the types of orientation sensors and their combinations are exemplary and in no way should be deemed to be limiting the scope of the invention.

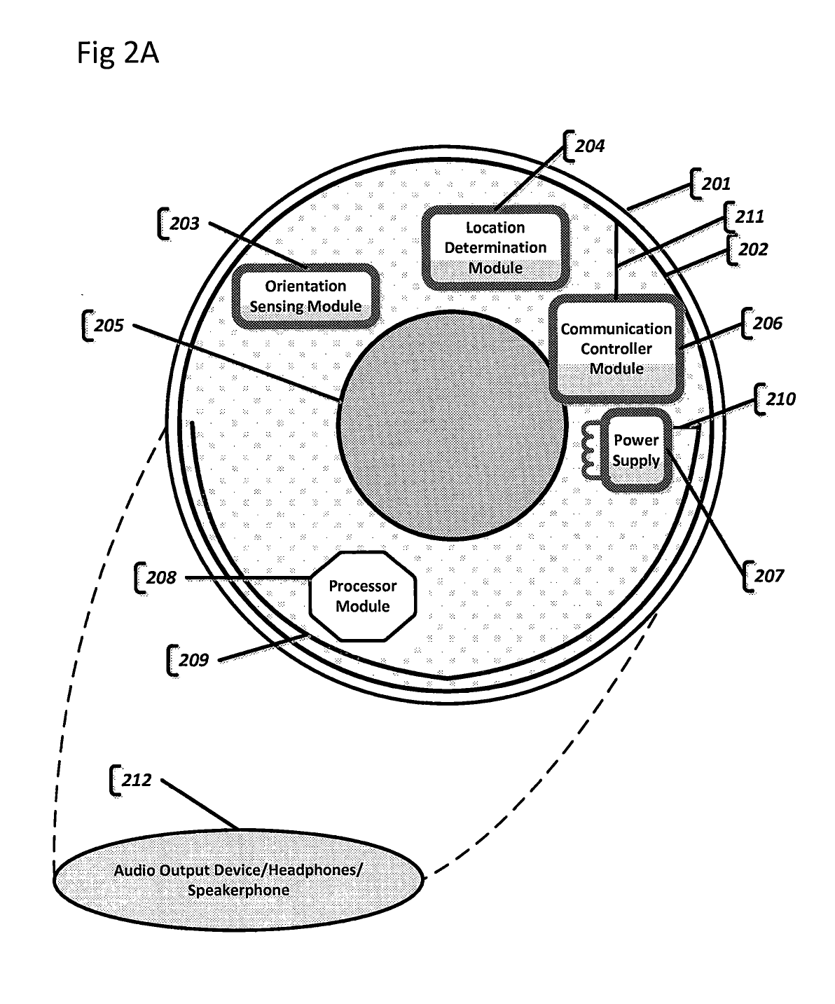

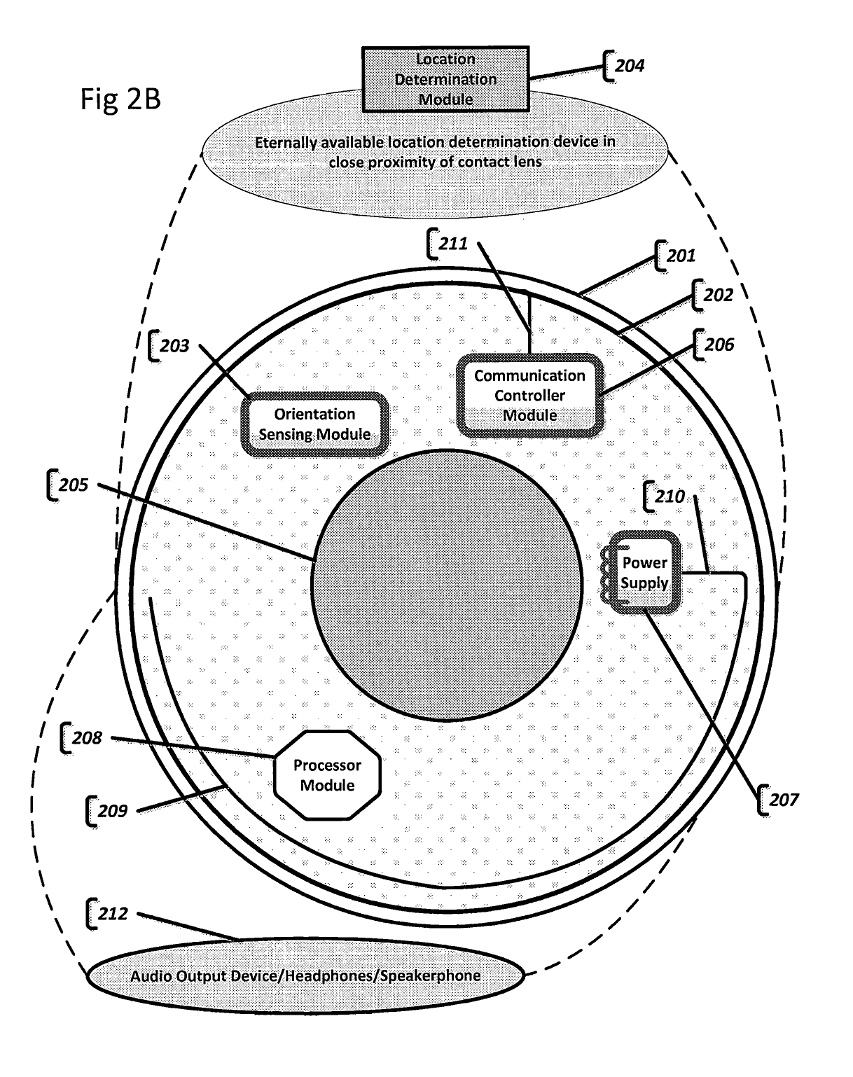

In one non-limiting, exemplary embodiment, as per FIGS. 2A and 2B, an active contact lens substrate 201 may be composed of transparent, semi-transparent or non-transparent composite material, or a combination of materials for different layers of substrate: for example, a combination of RGP and graphene, with embedded silver nanowires, serving as conducting materials to transmit electronic signal to the display component.

In one non-limiting, exemplary embodiment, an active contact lens substrate may be composed of transparent PMMA or RGP or other material with an acceptable degree of oxygen permeability and heat dissipation.

In one non-limiting, exemplary embodiment, an active contact lens substrate may be composed of various transparent polymer materials or any other material that can yield transparent substrate.

In one non-limiting, exemplary embodiment, the smart contact lens may be arranged with directional orientation sensor module (OSM) 203.

An active contact lens system is arranged with a location determination component, which may include, for example, GPS (Global Positioning System), Wi-Fi location determination mechanisms, GSM localization, LTE Cell tower localization, ground-based beacons or distance measurement devices/sensors and any other location coordinate determination sensors or methods.

In one non-limiting, exemplary embodiment, as per FIG. 2A, location determination module 204 may be embedded and integrated into the contact lens substrate.

In one non-limiting, exemplary embodiment, as per FIG. 2B, location determination module may be arranged on a nearby “smart” device and be remotely/wirelessly available. The nearby location determination device is “on the user” and is indicative of the user's location.

An onboard communication controller module 206 includes a radio antenna, it may optionally be an RF antenna, for wireless communication 202. Wireless radio antenna is arranged to communicate with an external server/nearby device, such as specialized glasses, helmet, cell phone and other smart devices. Antenna is connected to the communication controller module via connector 211.

The communication module may be used to: a) request information from a remotely available source; b) receive response from a remotely available service of GEO-enhanced information; also, c) a communication module may be used to get location information from a remotely available location determination module that may be located in close vicinity of the user's contact lens.

In one non-limiting, exemplary embodiment, a request from the communication controller module 206 may comprise current location information or directional orientation corresponding to and indicative of user's gaze. The request may optionally contain various contextual information. Current location information may comprise (xy) UTM (Universe Traverse Mercator) 2D coordinates or (xyz) UTM plus altitude—3D coordinates, or coordinates may be provided in any coordinate system. Contextual information may be used to configure/reconfigure a server to provide contextually relevant response for the current location or directional orientation of the user or both. For example, the context may be the name of the businesses or type of businesses and corresponding phone numbers as well as their exact address in the area corresponding to the user's gaze. Or in low visibility conditions, the context may be obtaining a photo realistic environs of the user, or navigation instructions, or any other GEO-enhanced information.

The communication controller module 206 may be used to communicate with a device containing location a determination module. For example, a contact lens may be connected with a smart phone or any other “smart” device via Bluetooth or Wi-Fi technology, provided that said “smart” device is located within a short distance from the contact lens (has to be on the same user) to provide accurate user location reading.

In one non-limiting, exemplary embodiment, as per FIG. 2A or 2B, a transparent or semi-transparent display 205 is embedded within or on contact lens substrate 201. The display is arranged at the center of the contact lens, so that it is positioned directly against the cornea of the wearer's eye.

In one non-limiting, exemplary embodiment, as per FIG. 2A or 2B, a non-transparent display 205 is embedded within or on the contact lens substrate 201. The display is arranged at the center of the contact lens, so that it is positioned directly against the cornea of the wearer's eye.

Generally, the human eye cannot focus on an object which is closer than a few centimeters from the eye. Regular display positioned immediately in front of the cornea of the eye will prompt the eye not to perceive an image in focus. This is a major difficulty in implementing an active contact lens with substantially transparent or semi-transparent or non-transparent display built into the lens. There are several approaches to the problem at hand.

In one non-limiting, exemplary embodiment, a Display 205 may comprise an integrated layer of micro lenses positioned over the actual display in such a way that each micro lens corresponds to each pixel on the display. The layer of micro lenses is directly facing the cornea of the eye. Micro lenses create a collimated beam of light directly projected onto the retina of the eye. Here, rays of light, representing an image, are arranged collinearly or nearly collinearly, and that leads to an image perceived by the perceiving subject as being far sourced, and hence “being in focus”.

In one non-limiting, exemplary embodiment, a Display 205 may comprise a variation of the Fresnel-like lens that focuses an image directly onto the retina of the eye.

It should be appreciated that there are a variety of other strategies and techniques possible to produce projections of an image onto the retina of the eye, so that it is perceived as being in focus. Above mentioned methods are exemplary and in no way should be conceived of as being limiting the scope of the invention.

In one non-limiting, exemplary embodiment, a contact lens may incorporate an onboard Processor module 208, which may function as a controller of the contact lens system; thereby coordinating proper operations of all components of the system.

In one non-limiting, exemplary embodiment, Processor module 208 may initiate a request to be sent to an external server. Processor module 208 processes the response from the server and analyzes the response data according to the context. Optionally, it enhances the data and computes an overlay of GEO-enhanced processed information corresponding to the current location and directional orientation of the user's gaze, onto a transparent or non-transparent display device. The resulting image is displayed on a transparent display.

Processor module 208 may comprise a) a processor, which may be a general purpose processor (CPU), b) operating RAM memory, ROM memory, EPROM memory, EEPROM memory, and non-volatile RAM (NVRAM) memory, and c) permanent memory.

In one non-limiting, exemplary embodiment, Processor module 208 may output audio information to an Audio output device 212.

In one non-limiting, exemplary embodiment, Processor module 208 may output visual information to the embedded Display device 205 and audio information to the Audio output device 212. Image data coupled with audio signal may create a better augmented reality experience. The signal to an audio device may be transmitted wirelessly, for example, via Wi-Fi or Bluetooth technology.

In one non-limiting, exemplary embodiment, Processor module 208 may be arranged to manage communication between a contact lens and a remotely available service.

In one non-limiting, exemplary embodiment, data corresponding to the current location and directional orientation may be requested from an external data source to be overlaid on top of the user's view, on a transparent display device, in real time.

In one non-limiting, exemplary embodiment, the system may request GEO-enhanced information from more than one source. Processor may analyze and merge the responses from various information sources to overlay onto the display device.

Processor module may determine the semantic context and consequently select relevant data from a data source to create the AR or VR experience for the user. Processor module may be responsible for processing images for an overlay of additional information over the image to create AR or VR experience for the user.

In one non-limiting, exemplary embodiment, as per FIG. 2A or 2B, Power supply module 207 provides electric power to the entire active contact lens. Power supply module may derive electric power from Energy transfer antenna 209. Antenna 209 may receive its power from an RF power source. Power supply may comprise a capacitor unit, a battery or an accumulator unit to continue to supply electricity from the local storage when the external power delivery is not available. The Power supply module is connected to the energy transfer antenna via a Connector contact 210.

In one non-limiting, exemplary embodiment, as per FIG. 2A or 2B, Power supply module 207 may comprise an integrated solar panel embedded into a contact lens substrate beyond the edge of the display device. The solar panel may be arranged to supply electric charge directly into the electric load or/and capacitor unit, battery or accumulator unit.

Power antenna 209 may also be used as a source of electric power to either provide electric charge in real time to the electric load, or charge/recharge onboard, integrated battery, accumulator, or capacitor.

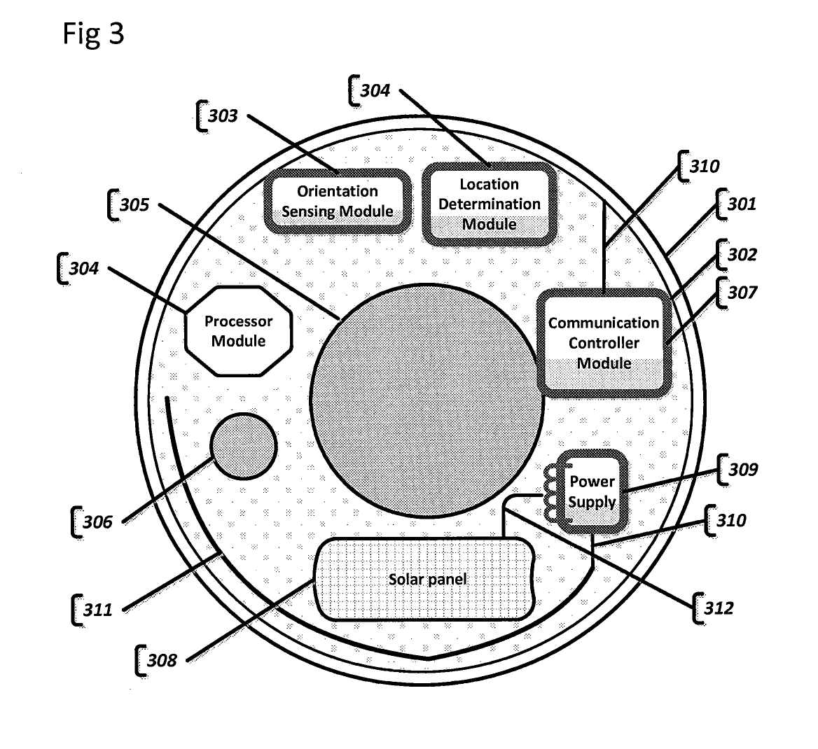

FIG. 3 presents yet another non-limiting, exemplary embodiment of a bionic contact lens with additional capabilities provided by integrating an image capture device into the substrate of the contact lens, in addition to a location determination module and an orientation module.

In one non-limiting, exemplary embodiment, the contact lens substrate 301 may incorporate an onboard, integrated Orientation sensor module 303. Orientation sensors may include a variety of compass, gyroscope, tilt sensor and accelerator. The Orientation module may include Inertial Measurement Unit (IMU) or Attitude Heading Reference System (AHRS). Sensors may be implemented with Micro-Electro-Mechanical Systems (MEMS) technology. Sensors may be implemented as Nano or micro sensors.

In one non-limiting, exemplary embodiment, the contact lens substrate 301 may incorporate an onboard or a remotely located, Location determination module 304. Location determination module 304 may comprise any of the following: GPS sensor-based or wireless location detection, location-based services (LBS), GSM localization. It may include ground-based beacons-based localization, distance measurement sensors, and an inertial navigation system (INS). It should be appreciated that the location determination module may be integrated into the contact lens substrate, or may be located in the vicinity of contact lens; for example, in smart glasses, in user's smart phone, or in any other smart device carried by the user, so that location of the location determination module is linked and is in direct correspondence to the user's location.

In one non-limiting, exemplary embodiment, the contact lens substrate 301 may incorporate an onboard integrated Communication controller module 307. The Communication module includes a wireless antenna 302 (it may be an RF antenna). Wireless radio antenna is arranged to communicate with an external server. The antenna is connected to the Communication controller module via Connector 310.

The Communication module may be used to a) request information from a remotely available source; b) receive a response from a remotely available service of GEO-enhanced information; also, c) the Communication module may be used to get location information from an off-board location determination module that may be located remotely but in close vicinity of the user's contact lens; d) send to the server image information collected by an integrated image capture device.

In one non-limiting, exemplary embodiment, the contact lens substrate 301 may incorporate an onboard processor/controller module 304.

In one non-limiting, exemplary embodiment, the contact lens may incorporate an onboard Processor module 304, which may function as a controller of the contact lens system, thereby coordinating proper operations of all components of the system.

In one non-limiting, exemplary embodiment, the Processor module 304 may initiate a request to be sent to an external server. Processor module 304 processes a response from the server and analyzes the response data according to the context. Optionally, it enhances the data and computes an overlay of GEO-enhanced processed information, corresponding to current location and directional orientation of the user's gaze, onto a transparent or a non-transparent display device. The resulting image is displayed on a transparent display.

Processor module 304 may comprise a) a processor, which may be a general purpose processor (CPU), b) operating RAM memory, ROM memory, EPROM memory, EEPROM memory, and non-volatile RAM (NVRAM) memory, and c) permanent memory.

In one non-limiting, exemplary embodiment, Processor module 304 may be arranged to manage communication between a contact lens and a remotely available service.

In one non-limiting, exemplary embodiment, Processor module 304 may output visual information to the embedded Display device 305 and audio information to Audio output device (not shown in FIG. 3). Image data coupled with audio signal creates a better augmented reality experience.

In one non-limiting, exemplary embodiment, Processor module 304 may be arranged to process image/video signal from an Image capture device 306 for object recognition, for example, surroundings (buildings, roads, etc.) being looked at by the user. Images or a sequence of images are generated by the Image capture device 306. The system requests relevant GEO-enhanced information from locally or remotely available source/service of GEO-enhanced information, based on current location and directional orientation of the user. The processor overlays relevant information onto the video stream from the Image capture device 306, in such a way, that objects of interest/objects being monitored have additional information displayed around or on them, based on configured context. Additional information may be displayed, on a semi-transparent or non-transparent display 305, as annotations, text or image information or as audio information being output to the audio device.

This technology may be applied, for example, to retail. As the wearer of the proposed herein bionic lens walks through a store or supermarket and looks at items on the shelves, images are processed for object recognition. Based on the object's location and object type identified, relevant information, such as pricing, relevant discounts, expiration date and any other contextual information about the objects of interest, is pulled from the source of GEO-enhanced information. The information is then superimposed and displayed in front of or projected onto the user's retina.

One non-limiting, exemplary embodiment of this technology, may be an enhanced navigation system where navigation instructions are computed and derived based on the user's location, as per Location module 304, and user's orientation, as per Orientation module 303. The navigation instructions are superimposed by the processor onto the image/video feed generated by the Image capture device 306, where additional information may be provided for objects of interest recognized in the video frames. Objects of interest may be cars on the road, buildings in the vicinity of the user, any other objects. Information may be retrieved from external or local sources of GEO-enhanced data and consequently the contextual information may be superimposed onto objects in the view.

In one non-limiting, exemplary embodiment, the contact lens includes Power supply 309. Power supply sub-system may consist of an onboard battery or capacitor. It may derive electric charge either from an onboard Solar panel 308, integrated into the lens substrate, or from RF antenna 311, dedicated to receiving/generating electric charge from nearby radio transmitting base. Solar element 308 is connected to the power supply by Connector 312.

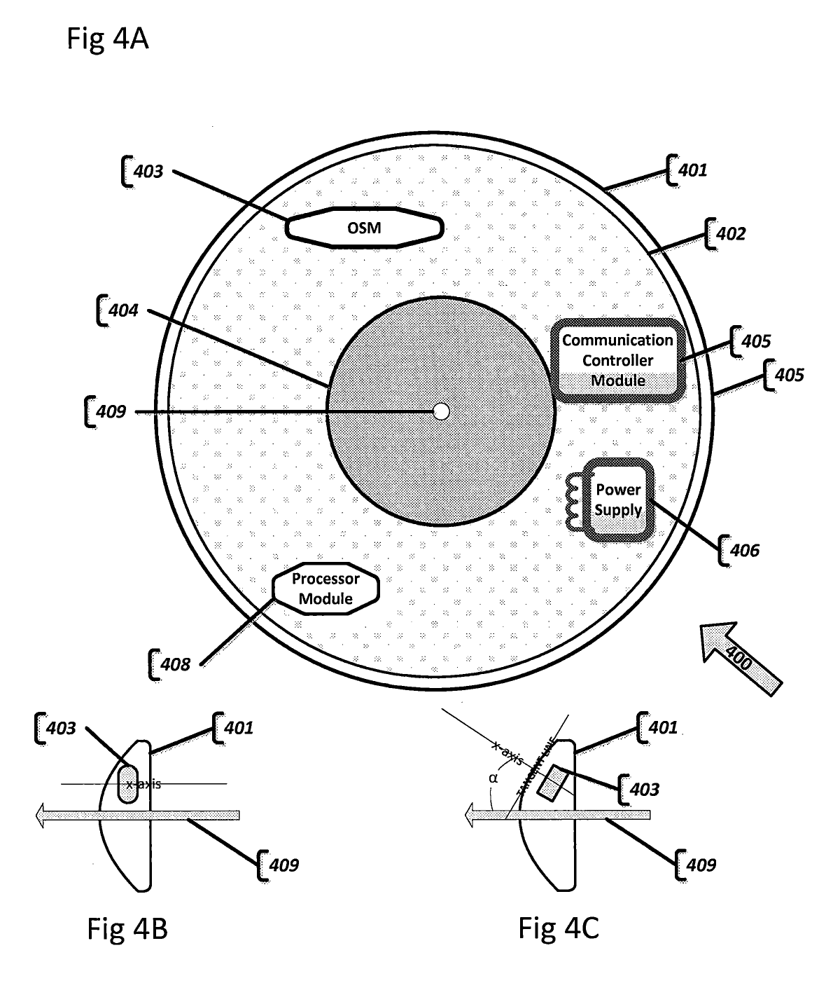

In one non-limiting, exemplary embodiment, as per FIG. 4A, a smart contact lens 400 is depicted. Contact lens substrate 401 contains an embedded Communication antenna 402, integrated into the substrate, and at least one orientation sensing module (OSM) 403, integrated into the contact lens substrate. An Orientation sensing module 403 may be embedded into the lens substrate in such a way as to have OSM's x-axis be perpendicular to the tangent line of the eye's center, whereas eye's centerline 409 and OSM's x-axis are essentially parallel as can be seen in FIG. 4B. Then, OSM's output is reflective of eye's orientation aka eye's gaze direction.

In one non-limiting, exemplary embodiment, an OSM 403 may be arranged under specific angle offset relative to the eye's centerline. As illustrated in FIG. 4C, an OSM may be embedded into the lens substrate in such a way as to have OSM's x-axis be perpendicular to the tangent line of the exact spot on the substrate where OSM is embedded. In case when there is one OSM used on substrate, OSM's x-axis will not be parallel to the eye's centerline 409; exact angle α deviation/offset between x-axis of the OSM and centerline of the eye 409 needs to be known in order for the processor module to compute direction of the eye, based on OSM's measurements, by factoring in the angle offset. Direction of the eye is equal to the centerline of the eye.

Lens substrate 401 is optionally arranged with an integrated transparent, semi-transparent or non-transparent Display device 404 for display of visual information, and a Communication module 405. Communication module 405 is arranged to wirelessly communicate with the correspondent service outside of the contact lens utilizing integrated RF antenna 407, which may be arranged near the perimeter of the contact lens. The contact lens integrates Power supply module 406. Power supply module 406 may incorporate an onboard battery to store electric charge; it may receive power from a solar panel integrated into lens substrate; or it may produce electric power via RF antenna from a nearby source of microwave radiation Other means of electric power production and storage are also possible.

In one non-limiting, exemplary embodiment, the Contact lens substrate 401 may incorporate Processor module 408. The Processor module is arranged to coordinate operation of a variety of components integrated into the contact lens, as well as, process information based on the changes in the position of the eye.

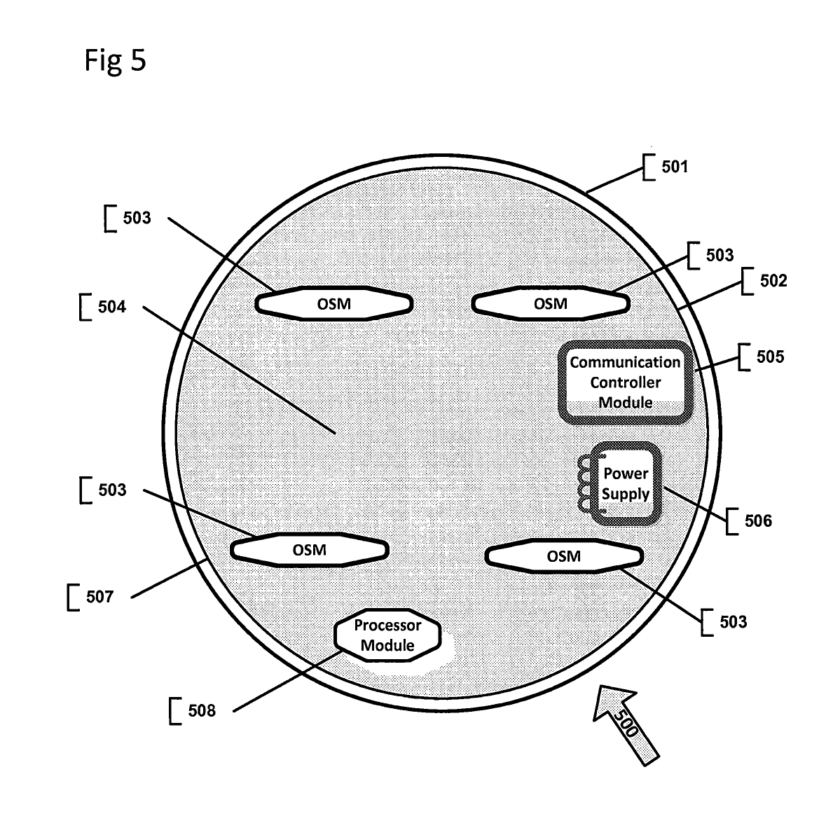

In one non-limiting, exemplary embodiment, as per FIG. 5, a smart contact lens 500 is depicted. Contact lens substrate 501 contains an embedded Communication antenna 502, integrated into the substrate, and a number of embedded orientation sensing modules (OSM) 503, integrated into the contact lens substrate. FIG. 5 depicts four OSMs 503 equidistantly arranged around the center of the contact lens, around the embedded Display 504, on the contact lens substrate.

An orientation sensing module 503 may be embedded into the lens substrate in such a way as to have OSMs' x-axis be perpendicular to the tangent line of the eye's center, where eye's centerline and OSM's x-axis are substantially parallel to each other. The parallel positioning of OSMs, relative to eye's centerline, would allow for OSMs' measurements to be reflective of eye's orientation and therefore to be reflective of the direction of the contact lens wearer's gaze. The system may compute average vector values of the number of OSMs to minimize margin of error in determination of orientation of the contact lens and eye's gaze.

In one non-limiting, exemplary embodiment, an OSM 503 may be arranged under a specific angle offset relative to the eye's centerline. OSM may be embedded into the lens substrate in such a way as to have OSM's x-axis be perpendicular to the tangent line to the surface of the contact lens, at the exact location on the substrate where OSM is embedded. OSMs' x-axis will not be parallel to the eye's centerline. Furthermore, the orientation of the eye may be computed by processor module, based on OSM's measurements. To compute the orientation of the eye, the system may rely on basic trigonometry or vector mathematics or a variety of other computational models. The proposed system may determine a multi-dimensional orientation, namely three-dimensional in (x, y, z) axes.

An exact angle deviation may be known at the time of lens manufacture or may be computed dynamically by the system as long as exact position, on the contact lens substrate, of every uniquely identifiable OSM is known.

Furthermore, the contact lens may be calibrated at the beginning of use, where the direction of the eye's centerline axis may be correlated with particular OSM's measurements from each OSM involved. As part of the calibration process, an angle shift coefficient may be determined between each OSM's x-axis and eye's centerline axis. Every OSM's angle shift coefficient may be used to compute orientation of the eye during normal operation of the contact lens.

Combining several OSMs on the contact lens enables the system to compute the orientation or gaze of the eye by averaging output of each of the OSM. This method reduces the margin of error, and hence, increases precision of the direction or gaze estimation.

Lens substrate 501 is arranged with optionally integrated display device 504 for the display of visual information, and a Communication module 505. Communication module 505 is arranged to wirelessly communicate with the correspondent service outside of the contact lens utilizing an integrated RF antenna 507, which may be arranged at the perimeter of the contact lens. The contact lens integrates Power supply module 506. Power supply module 506 may incorporate an onboard battery/accumulator/capacitor to store electric charge. It may receive power from a solar panel integrated into lens substrate, or it may produce electric power via RF antenna wirelessly from a nearby source of microwave radiation. Other sources and methods of electric power generation and storage may be considered.

In one non-limiting, exemplary embodiment, Contact lens substrate 501 may incorporate Processor module 508. The Processor module is arranged to coordinate operation of the components integrated into the contact lens; process information from OSMs and determine direction of gaze, as well as, process information based on the changes in the position of the eye.

In one non-limiting, exemplary embodiment, a group of orientation sensors 503, may be positioned equidistantly from each other, around the center of the eye. Positioned so, OSMs may be utilized to determine the position of each OSM component relative to the horizontal or vertical lines of the eye, and hence, determine two dimensional orientation of the contact lens relative to the eye. Wherein, horizontal line of the eye is defined as horizontal meridian of the eye and is horizontal to the eye gaze direction.

Wherein, vertical line of the eye is defined as vertical meridian of the eye and is vertical relative to the eye gaze direction.

In current exemplary embodiment, each OSM on the contact lens is uniquely identifiable by processing module. In one non-limiting, embodiment, there are many OSMs integrated into the contact lens. In one non-limiting, exemplary embodiment, each GSM's x-axis is arranged perpendicular to the tangent line of the exact spot on the substrate where OSM is embedded. In such case, the exact angle deviation between the x-axis of the OSM and the x-axis of the center of the eye, needs to be known, in order for the processor module to determine orientation of the eye, based on OSM's measurements, by factoring in angle offset. In this embodiment, OSMs are not aligned to the center of the eye and have differing relative axes (x,y,z), for which they measure direction of ambient magnetic field. Magnetometer may be multidimensional, for example 9-axis, 6-axis, 3-axis, 2-axis, or single-axis. For the purposes of current exemplary embodiment, magnetometers are tri-axial. Magnetometers, in each OSM, will yield different direction measurements for their corresponding (x,y,z) axis. Based on the output of each magnetometer and predefined, known distance between each OSM and center of the eye, Processor module 508 can compute horizontal (x-axis) and vertical (y-axis) disposition/coordinate of the contact lens substrate, of each uniquely identifiable OSM. Hence, propounded contact lens system can orient itself two dimensionally, in terms of up/down/left/right of the contact lens relative to the horizontal or vertical line of the eye. The processor module may compute directional vector value or angle shift value, for example, to connote current roll coefficient (x-axis) relative to the horizon. Alternatively, the system may measure roll coefficient relative to the vertical line. Roll coefficient also represents the horizontal or vertical orientation.

Each of the two contact lens, once attached to the eye may be worn in a variety of orientations relative to the eye. Each contact lens may be orientated differently relative to the eye and to the other paired contact lens.

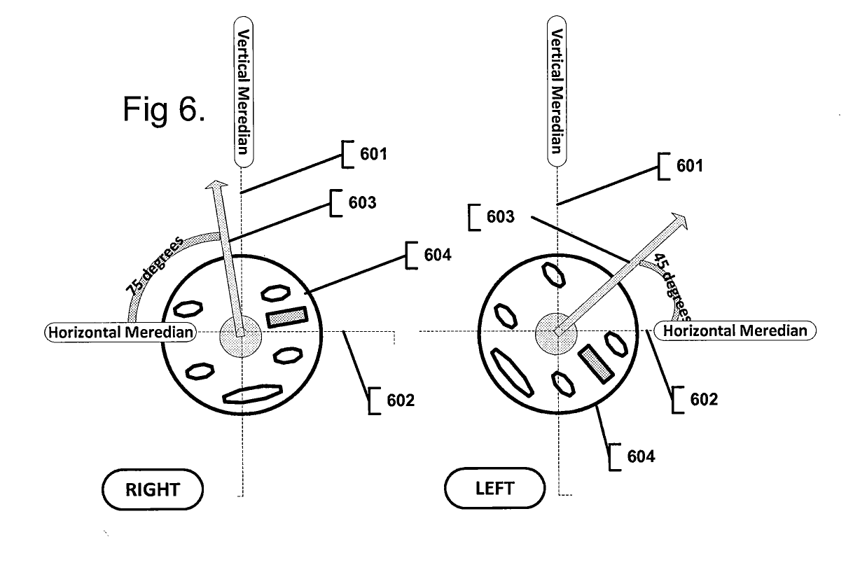

In one non-limiting, exemplary embodiment, FIG. 6 further demonstrates an aspect of proposed invention. The drawing depicts two contact lenses, one per each eye (left and right lens). 604 depicts the contact lens substrate with a variety of electronic, optical and electro optical components integrated into it. 601 shows a vertical line of the eye and 602 indicates a horizontal line of the eye (x and y axis). 603 is an arrow, clearly showing the two dimensional alignment of both contact lenses on the left and right eye. Furthermore, the angle of inclination of the contact lens in two dimensions, relative to the horizontal line, is given in degrees: for the right eye: 75 degrees, and for the left eye: 45 degrees, relative to the horizontal line.

Such two dimensional orientation capability, relative to the horizontal or vertical line of the eye, has a number of important uses. One critically important application is a capability of an embedded display system to align a displayed image relative to the horizontal and vertical meridians of the eye. To this end, the display system may need to dynamically index its display pixels, based on current two dimensional orientation of the particular contact lens, in order to always display data in proper two dimensional orientation.

Furthermore, in the current non-limiting, exemplary embodiment, the Processor module 508, may utilize current roll coefficient to control display pixel matrix of either substantially transparent or semi-transparent or non-transparent Display 504.

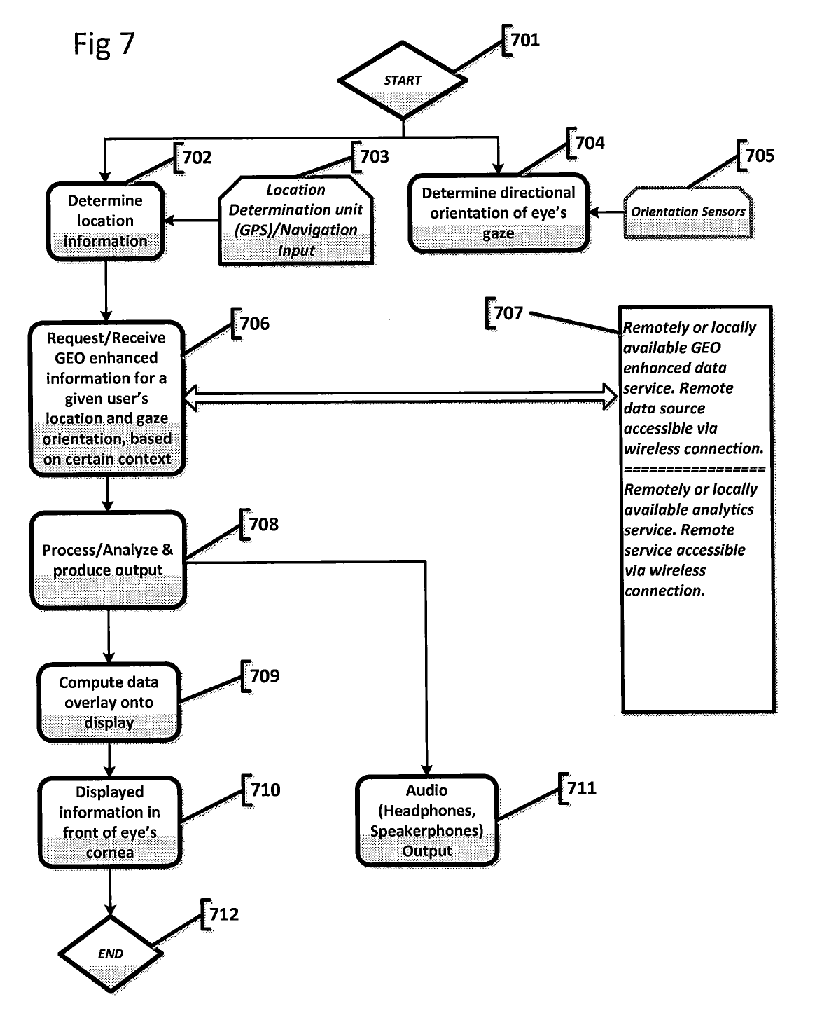

FIG. 7, describes the process flow and operation of the present invention. The process starts at 701, for example, by voice command, or by pressing a button on a smart phone to start the operation of the system, or by a predefined series of eye blinks (denoting activation of the process), or an AR application may start the process. At step 702, current location of the user is determined using location determination unit 703, which may comprise any of the following: GPS sensor-based or wireless location detection, location-based services (LBS), GSM localization. It may also include ground-based beacons-based localization, distance measurement sensors, inertial navigation system (INS). It should be appreciated that the location determination module may be integrated into the contact lens substrate or may be located in the vicinity of the contact lens, for example, on user's smart phone or any other smart device carried by the user; so that location of the location determination module is linked and is in direct correspondence to the user's location.

In one non-limiting exemplary embodiment, at step 704, the direction of the eye gaze is determined by Orientation sensors 705, integrated into the contact lens. Orientation sensors may include a variety of compass, gyroscope, an accelerometer, magnetic sensors, tilt sensors or other sensors and methods that may be used to determine the direction of the user's gaze.

In one non-limiting exemplary embodiment, at step 705, the Orientation module comprised of a variety of orientation sensors integrated into the substrate of contact lens, determines the directional orientation of the user's gaze.

In one non-limiting exemplary embodiment, at step 706, the system issues a request, according to the context configured in the system at any given point of time. The request may contain point of interest information, namely, location coordinates or direction of the user's gaze parameters, as well as, optionally, the context for the response. Response may be generated based on either locally stored information or based on remotely stored information 707. The response generated may be either raw/stored data as is or it may be pre-processed according to the provided context. For example, the response may contain navigation instructions or additional, descriptive information about objects in the vicinity of the user.

Once relevant information has been received, the system may be configured to adjust what data is displayed to the user, based on further movements of the eyes.

In one non-limiting exemplary embodiment, information fetched may contain GEO-enhanced information.

In one non-limiting exemplary embodiment, information fetched may contain visual information, in the form of an image or video.

In one non-limiting exemplary embodiment, information fetched may be in the form of text.

In one non-limiting exemplary embodiment, information fetched may be audio information.

Information may be pre-processed on the remote server or locally by the Processing module of the system at step 708. Information processing enhances information according to the context configured and determines the mode of output of the information to the user. Mode may be visual or audible or combined visual and audible.

In one non-limiting exemplary embodiment, at step 708, information related to the location of the user, in the form of annotations, images or video may be superimposed onto the real world view. The information is superimposed with respect to user's gaze direction.

In one non-limiting exemplary embodiment, information (visual information) processed at step 709 is overlaid onto a display device, embedded into the lens substrate, to be displayed in front of the user's retina at step 710.

In one non-limiting exemplary embodiment, information (audio information) processed at step 108, is output to the headphones or speakerphones at step 711.

The process terminates, at step 712, with, for example, a voice command used by the user, or by pressing a control on a smart phone-based application that controls the system, or by a pre-defined eye blink pattern denoting “end” of operations.

It is to be understood that the all above descriptions and embodiments are intended to be illustrative, and not restrictive. For example, the above-described embodiments (and/or aspects thereof) may be used in combination with each other. In addition, many modifications may be made to adapt a particular situation or material to the teachings of the subject matter disclosed herein without departing from the spirit of the invention and its scope. Many other embodiments will be apparent to those of skill in the art upon reviewing the above description. The scope of the subject matter disclosed herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects.

Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. This written description uses examples to disclose the various embodiments of the subject matter disclosed herein, including the best mode, and also to enable any person skilled in the art to practice the various embodiments of the subject matter disclosed herein, including making and using any devices or systems and performing any incorporated methods. The patentable scope of the various embodiments of the subject matter disclosed herein is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed:

1. A contact lens system comprising:
a contact lens substrate;
at least one, integrated into the said contact lens substrate, orientation sensing module;
a power supply module, arranged to electrically power electronic components of the system;
a processing module configured to:
obtain orientation information from at least one integrated orientation sensing module;
and determine orientation of the contact lens.

2. A contact lens system of claim 1, further comprising:
a communication module arranged with an integrated, into the said contact lens substrate, communication antenna and configured to communicate with a remote communication service;
wherein, communication module is configured to send request signal to a remote service and to receive response signal from said remote service;
wherein, the request may comprise current contact lens orientation information or location information.

3. A contact lens system of claim 1, further comprising:
a location determination module, arranged to determine current location of the user;
wherein, location determination module may be an onboard location determination module, integrated into the said contact lens substrate or location determination module may be arranged outside of the contact lens substrate, in close proximity of the contact lens.

4. A contact lens system of claim 1, further comprising:
an integrated, into the said contact lens substrate, transparent or semi-transparent or non-transparent display unit, positioned at the middle of the contact lens;
wherein, display unit is eye facing;
wherein, display unit is optionally integrated with an embedded Fresnel-like lens component.

5. A contact lens system of claim 1, further comprising:
the said processing module, arranged to compute orientation of the contact lens in three dimensions (x,y,z) and to determine the direction of contact lens wearer's eye gaze.

6. A contact lens system of claim 1, further comprising:
the said processing module, arranged to compute orientation of the contact lens in two dimensions (x,y) and to determine the orientation of the contact lens relative to horizontal or vertical meridians of the eye.

7. A method comprising:
determining orientation of the contact lens using: at least one, integrated into the said contact lens substrate, orientation sensing module;
supplying electric power, utilizing power supply module, arranged to electrically power electronic components of the system;
processing orientation information, obtained from at least one orientation sensing module to determine orientation of the contact lens.

8. A method of claim 7, further comprising:
communicating with remote service, utilizing an integrated into the said contact lens substrate, RF antenna;
wherein communication module is configured to send request signal to a remote service and to receive response signal from said remote service;
wherein, the request may comprise current contact lens orientation information or location information.

9. A method of claim 7, further comprising:
determining location of the user or contact lens, utilizing a location determination module, arranged to determine current location of the user;
wherein, location determination module may be an onboard location determination module, integrated into the said contact lens substrate or location determination module may be arranged outside of the contact lens substrate, in close proximity of the contact lens.

10. A method of claim 7, further comprising:
displaying information on an integrated, into the said contact lens substrate, transparent or semi-transparent or non-transparent display unit, positioned at the middle of the contact lens;
wherein, display unit is eye facing;
wherein, display unit is optionally coupled with an embedded Fresnel-like lens component to put image displayed into focus.

11. A method of claim 7, further comprising:
determining orientation of the contact lens in three dimensions (x,y,z), based on information derived from orientation sensing module; wherein orientation of the contact lens is also an indicator of the direction of contact lens wearer's eye gaze.

12. A method of claim 7, further comprising:
determining orientation of the contact lens in two dimensions (x,y), based on information derived from orientation sensing module; wherein orientation of the contact lens is indicative of the position of the contact lens relative to horizontal or vertical meridians of the eye.
